(19) United States
(12) Patent Application Publication
(10) Pub. No.: US 2010/0174546 A1
(43) Pub. Date: Jul. 8, 2010

(54) Sound recognition apparatus of robot and method for controlling the same

(75) Inventors: Ki Beom KIM, Seongnam-si (KR); Ki Cheol PARK, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/654,822

(22) Filed: Jan. 5, 2010

(30) Foreign Application Priority Data
Jan. 6, 2009 (KR) 10-2009-890

(51) Int. Cl. G10L 21/00

(52) U.S. Cl. 704/275; 901/46

(57) ABSTRACT

Disclosed is a sound recognition apparatus of a robot and a method for controlling the same. The sound recognition apparatus senses sound and determines if the sound is for communication by comparing the sensed sound with a preset reference condition. If the sound is for conversation, the movement of the robot is controlled. The method includes comparing the sound sensed by the robot with a preset reference condition, thereby determining if the sound is for communication with a user. When a conversation is intended, recognition rate is increased, and the robot is moved according to the intention of communication.

### CROSS-REFERENCE TO RELATED APPLICATIONS

This application claims the benefit of Korean Patent Application No. 10-2009-0000890, filed on Jan. 6, 2009, in the Korean Intellectual Property Office, the disclosure of which is incorporated herein by reference.

### BACKGROUND

1. Field

The disclosure relates to a sound recognition apparatus of a robot and a method for controlling the same, capable of sensing various kinds of sound and controlling movement of the robot based on the sensing result.

2. Description of the Related Art

Recently, the most basic technology of a human-robot interaction used to provide robots with artificial intelligence is an SSL (Sound Source Localization) technology that aims to allow the robot to track a calling sound of the user such that the robot approaches the user.

Many studies of the SSL technology have been pursued. SSL technology may allow the robot to respond to calling voice sound or calling acoustic sound of the user, depending on audio information of microphones. Thus, the robot tracks a direction of the sound to move toward the user. Such a technology is generally known in the art.

Since various types of sound occur in the actual user environment, the SSL technology enables the robot to take the various sounds, determine if the sounds are for communication, and then takes action corresponding to the determination result. To this end, the robot must precisely determine if the sound is for communication. In order to precisely determine the intention of the user, the robot must perform a preliminary operation of recognizing voice sound and acoustic sound in the same way human does.

### SUMMARY

Accordingly, it is an aspect of the disclosure to provide a sound recognition apparatus of a robot and a method for controlling the same, capable of sensing various kinds of sounds and controlling movement of the robot based on the sensing result.

Additional aspects and/or advantages of the disclosure will be set forth in part in the description which follows and, in part, will be apparent from the description, or may be learned by practice of the disclosure.

The foregoing and/or other aspects of the disclosure are achieved by providing a sound recognition apparatus of a robot. The sound recognition apparatus includes a sound sensing unit to sense a sound, and a determination module unit, which determines if the sensed sound is for communication by comparing the sensed sound with a preset reference condition.

The sound recognition apparatus further includes a sound pressure measurement unit, which measures sound pressure of the sensed sound, wherein the determination module unit determines an emergency situation by comparing the measured sound pressure with a reference sound pressure.

The sound recognition apparatus further includes an alarm sound output unit, which outputs an alarm sound if the determination module unit determines that the emergency situation occurs.

The sound recognition apparatus further includes a control unit, which controls the robot such that the robot moves in a direction of the sensed sound if the determination module unit determines the sound is for communication.

It is another aspect of the disclosure to provide a sound recognition apparatus of a robot. The sound recognition apparatus includes a sound sensing unit to sense a sound, a determination module unit, which determines if the sensed sound is for communication by comparing the sensed sound with a preset reference condition, and a control unit, which controls the robot such that the robot moves in a direction of a sound having a highest priority when a plurality of sounds for communication exist.

The sound recognition apparatus further includes a sound pressure measurement unit, which measures sound pressure of the sensed sound, wherein the determination module unit determines an emergency situation by comparing the measured sound pressure with a reference sound pressure.

The sound recognition apparatus further includes a set-up unit, which sets up a priority corresponding to the sounds.

The determination module unit includes a voice sound module, which detects a voice sound from the sensed sound to determine if the voice sound is for communication, and an acoustic sound module, which detects an acoustic sound from the sensed sound to determine if the acoustic sound is for communication.

It is another aspect of the disclosure to provide a method of controlling sound recognition of a robot. The method includes sensing a sound, determining if the sensed sound is for communication comprising comparing the sensed sound with a preset reference condition, and controlling movement of the robot if determined that the sound is for communication.

The determination if the sound is for communication includes detecting a voice sound from the sound, recognizing a keyword from the detected voice sound, and determining if the keyword corresponds to one of a plurality of address-terms, which are preset.

The determination if the sound is for communication includes detecting acoustic sound from the sound, and comparing the detected acoustic sound with a plurality of templates, which are preset.

The method further includes measuring sound pressure of the sensed sound, and comparing the measured sound pressure with a reference sound pressure, thereby determining an emergency situation.

The method further includes providing a security service in the event of an emergency.

It is another aspect of the disclosure to provide a method of controlling sound recognition of a robot. The method includes sensing a sound, determining if the sensed sound is for communication comprising comparing the sensed sound with a preset reference condition, determining a priority of a plurality of sounds if determined that the sound is for communication, and controlling the robot such that the robot moves in a direction of the sensed sound having a highest priority.

The method further includes measuring sound pressure from the sensed sound, and comparing the measured sound pressure with a reference sound pressure, thereby determining an emergency situation.

The determination if the sound is for communication has priority higher than priority of the determination of the emergency situation.

The determination of the priority for the sound includes determining recognition scores of the sounds, and applying a weight to the recognition score corresponding to the priority, thereby operating a weight score.

The sensing of the sound includes detecting voice sound from the sound, recognizing a keyword from the detected sound, comparing the keyword with a plurality of address-terms, which are preset, to determine a consistency between the keyword and the address-terms, and determining a recognition score of the address-terms being consistent with the keyword.

The sensing of the sound includes detecting acoustic sound from the sensed sound, and comparing a distance between a pattern of the detected acoustic sound and a pattern of a plurality of templates, which are preset, thereby recognizing a target acoustic sound.

In the recognition of the target acoustic sound, the template corresponding to a minimum distance is regarded as the target acoustic sound.

An interval between the pattern of the detected acoustic sound and a pattern of the target acoustic sound is calculated, thereby determining if the sound is for communication.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a block diagram showing a sound recognition apparatus of a robot according to an embodiment;

FIGS. 2 to 4 are block diagrams showing a detailed structure of the sound recognition apparatus of the robot according to the embodiment;

FIG. 5 is a flowchart representing a sequence of a sound recognition control of the robot according to the embodiment;

FIGS. 6 and 7 are flowcharts representing the detailed sequence of the sound recognition control of the robot according to the embodiment; and

FIG. 8 is a flowchart representing a sequence of a sound recognition control of a robot according to another embodiment.

### DETAILED DESCRIPTION

Reference will now be made in detail to the embodiments of the disclosure, examples of which are illustrated in the accompanying drawings, wherein like reference numerals refer to the like elements throughout. The embodiments are described below to explain the disclosure by referring to the figures.

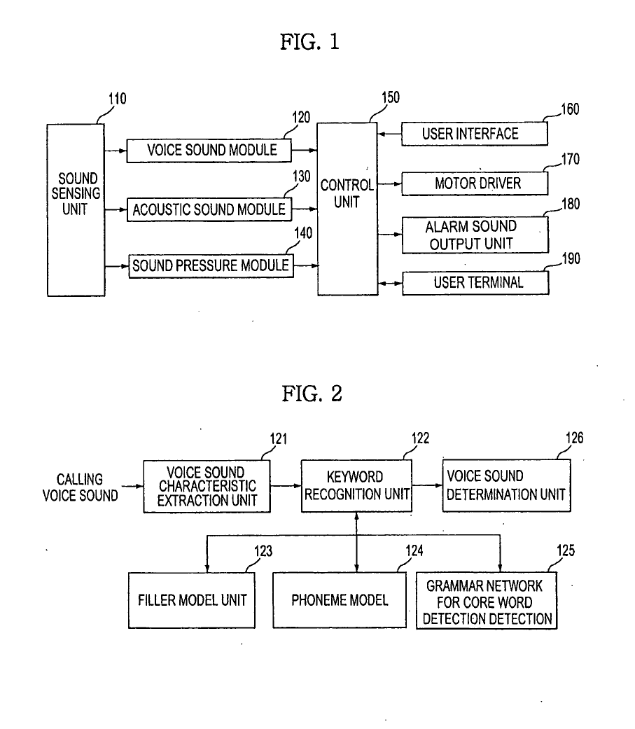

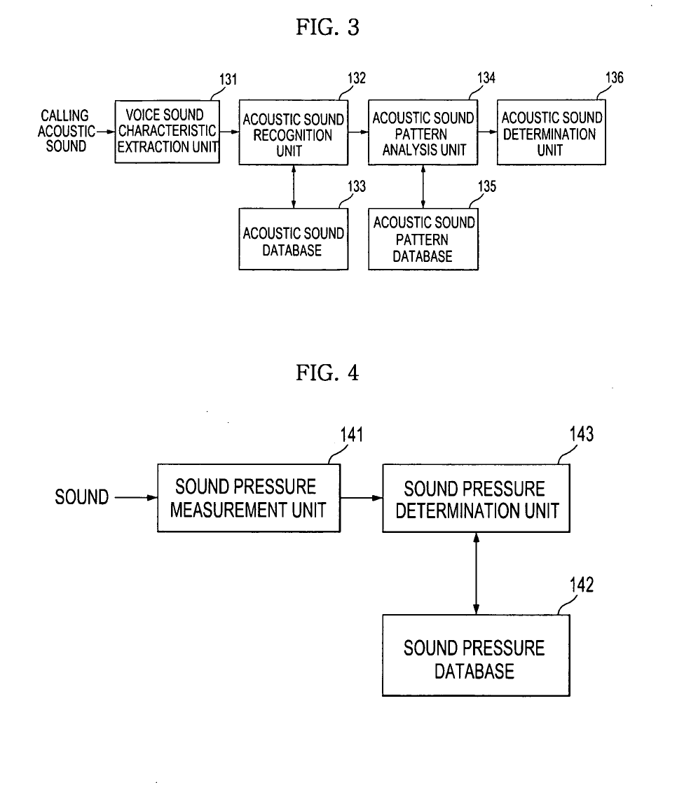

FIG. 1 is a block diagram showing a sound recognition apparatus of a robot according to an embodiment. The sound recognition apparatus of the robot includes a sound sensing unit 110, determination module units 120, 130 and 140, a control unit 150, a user interface 160, a motor driver 170 and an alarm sound output unit 180. FIG. 2 is a block diagram showing a detailed structure of a voice sound module 120 of the determination module units in the sound recognition apparatus of the robot according to the embodiment, FIG. 3 is a block diagram showing a detailed structure of an acoustic sound module 130 of the determination module units in the sound recognition apparatus of the robot according to the embodiment, and FIG. 4 is a block diagram showing a detailed structure of a sound pressure module 140 of the determination module units in the sound recognition apparatus of the robot according to the embodiment.

The sound sensing unit 110 senses various kinds of sound occurring in a space where the robot exists, and transfers the sensed sound to the voice sound module 120, the acoustic sound module 130 and the sound pressure module 140. The sound sensing unit 110 is provided in the form of a microphone. The sound sensing unit 110 receives sound waves of the sound to generate electric signals corresponding to vibrations of the sound waves.

The determination module units 120, 130 and 140 include the voice sound module 120, the acoustic sound module 130 and the sound pressure module 140 and detect at least one of voice sound and acoustic sound from the sound transferred from the sound sensing unit 110. In addition, the determination module units 120, 130 and 140 determine if at least one of the detected voice sound and acoustic sound are for communication, and transfer the determination result to the control unit 150. In addition, the determination module units 120, 130 and 140 measure sound pressure and compare the measured sound pressure with a reference sound pressure, thereby determining if the measured sound pressure corresponds to sound pressure in an emergency. The determination result is transmitted to the control unit 150.

The sound, which is used to communicate with the robot, includes calling voice sound and calling acoustic sound. The calling voice sound includes an address-term to call the robot, such as a name of the robot, a vocative postposition (i.e. ‘hey’, ‘hey man’ or ‘yo’, an exclamation (i.e. ‘wow’ or ‘yeah’) or a second personal pronoun (i.e. ‘you’). The calling acoustic sound includes sound to call, such as a clap sound represented with a plurality of patterns.

The determination module unit will be described below in detail.

As shown in FIG. 2, the voice sound module 120 serves as a determination module, which detects a voice sound signal from the sounds transferred from the sound sensing unit 110, determines if the detected voice sound signal corresponds to the calling voice sound for communication, and transmits the determination result to the control unit 150. The voice sound module 120 includes a voice sound characteristic extraction unit 121, a keyword recognition unit 122, a filler model unit 123, a phoneme model unit 124, a grammar network 125 detecting the keyword and a voice sound determination unit 126.

The voice sound characteristic extraction unit 121 detects the voice sound signal from the sound sensed by the sound sensing unit 110 and calculates a frequency characteristic of the detected voice sound signal at each frame, thereby extracting a characteristic vector included in the voice sound signal. To this end, the voice sound characteristic extraction unit 121 is provided with an analog-digital conversion unit converting an analog voice sound signal into a digital voice sound signal. The voice sound characteristic extraction unit 121 divides the converted digital voice sound signal and extracts the characteristic vector of the divided voice sound signal to transfer the extracted characteristic vector to the keyword recognition unit 122.

The keyword recognition unit 122 recognizes a keyword based on the characteristic vector for the extracted voice sound signal using the filler model unit 123, the phoneme model unit 124 and the grammar network 125. That is, the keyword recognition unit 122 determines if the recognized keyword corresponds to the address-term according to a likelihood result for the filler model unit 123 and the phoneme model unit. If the recognized keyword corresponds to the address-term, the keyword recognition unit 122 determines if a sentence pattern including the keyword exists by using the grammar network 125 based on the recognized keyword. That is, the grammar network 125 has a plurality of sentence patterns including a plurality of address-terms.

The filler model unit 123 serves as a model to search for a non-keyword and performs a modeling for each non-keyword or all non-keywords. Such a filler model unit 123 calculates a likelihood of the extracted characteristic vector. Weight is given to the calculated likelihood to determine if the voice sound corresponds to the filler model 123. The sound corresponding to the filler model unit 123 includes a predetermined sound such as “em . . . ”, “well . . . ” and “ . . . yo” that are mainly used when the user vocalizes. In addition, the phoneme model unit 124 calculates the likelihood of the characteristic vector, which represents a state of approaching to the address-term, by comparing the extracted characteristic vector with the stored keyword.

If the voice sound determination unit 126 recognizes that the keyword corresponds to one of the address-terms based on the likelihood, which is calculated from the filler model unit 123 and the phoneme model unit 124, the voice sound is regarded to have an intention of communication. Therefore, the voice sound determination unit 126 transfers the determination result to the control unit 150 and stores a recognition score for the voice sound.

The acoustic sound module unit 130 serves as a determination module, which recognizes clap sound and compares a pattern of the recognized clap sound with a pattern of a predetermined clap sound, thereby determining if the clap sound is calling acoustic sound for communication. As shown in FIG. 3, the acoustic sound module 130 includes a voice sound characteristic extraction unit 131, an acoustic sound recognition unit 132, an acoustic sound database 133, an acoustic sound pattern analysis unit 134, an acoustic sound pattern database 135 and an acoustic sound determination unit 136. Since the acoustic sound, such as a clap sound, has a relatively precise characteristic pattern as compared with the voice sound, the acoustic sound may be recognized at a high rate.

The acoustic sound characteristic extraction unit 131 detects an acoustic sound signal from the sound sensed in the sound sensing unit 110, and calculates a frequency characteristic of the detected acoustic sound signal at each frame, thereby extracting a characteristic vector included in the acoustic sound signal. That is, the voice characteristic extraction unit 131 extracts a predetermined calling sound for communication, for example, characteristic acoustic sound of a clap sound. The predetermined clap sound represents a pulse-type spectrogram over the entire frequency band for a short period of time, in particular, the clap sound represents strong energy of a radio frequency band as compared with the voice sound and noise. Main parameters used to extract the acoustic sound include energy of a current frame, energy of radio frequency band in the current frame, energy variation between frames, average energy and average radio frequency component energy in a noise section, duration of the extracted acoustic sound energy and variation decreased with the lapse of time.

The acoustic sound recognition unit 132 determines if the detected acoustic sound, which has been sensed by the sound sensing unit 110, corresponds to a target acoustic sound, and performs a recognition process to match patterns of the extracted characteristic vector. The pattern matching is performed by a template matching scheme, in which a plurality of templates corresponding to acoustic sound for communication, for example, a plurality of templates for clap sound, are predetermined. The acoustic sound recognition unit 132 compares the pattern of the extracted characteristic vector with a pattern of the templates to calculate a distance between the two patterns. A minimum distance between the two patterns is compared with a reference distance, and it is determined whether the minimum distance is equal to or greater than the reference distance. If the minimum distance is equal to or greater than the reference distance, a template corresponding to the minimum distance is recognized as the target acoustic sound. After that, a recognition score of the acoustic sound corresponding to the minimum distance is checked and stored.

Information on the templates corresponding to a plurality of clap sounds is stored in the acoustic sound database 133.

If the detected acoustic sound, which has been sensed in the sound sensing unit 110, is determined as the target acoustic sound included in the preset acoustic sound database 133, the acoustic sound pattern analysis unit 134 compares an interval of the pattern of the detected acoustic sound, which is determined as the target acoustic sound, with an interval of the pattern of the target acoustic sound to inspect if the pattern of the detected acoustic sound and the pattern of the target acoustic sound are generated at the same interval, thereby reducing the likelihood of a false alarm. When checking the interval of the pattern of the detected acoustic sound, the detected acoustic sound is induced such that the pattern of the detected acoustic sound is output corresponding to the interval of the pattern of the target acoustic sound, and the acoustic sound pattern analysis unit 134 operates only when the pattern of the detected acoustic sound is generated at the same interval as the pattern of the target acoustic sound. Information on the intervals of patterns corresponding to clap sounds is stored in the acoustic sound pattern database 135.

In this case, a minimum value and a maximum value of the intervals of the patterns are set to adjust the false alarm and a false rejection. The false alarm is reduced and the false rejection is increased as a difference between the minimum value and the maximum value is reduced and the false alarm is increased and the false rejection is reduced as the difference between the minimum value and the maximum value is increased, which is called “trade-off”.

The false alarm represents an error in which the acoustic sound pattern analysis unit 134 operates by erroneously recognizing the target acoustic sound. The false rejection represents an error in which the acoustic sound pattern analysis unit 134 does not operate even though the sound is the target acoustic sound.

The sound pressure module 140 is a determination module to measure loud sound, which is rarely generated in a daily life to notify the user of a danger situation in a case that an intruder breaks into a public institute or home, or in an emergency situation. As shown in FIG. 4, the sound pressure module 140 includes a sound pressure measurement unit 141, a sound pressure database 142 and a sound pressure determination unit 143.

The sound pressure measurement unit 141 measures pressure of the sound transferred from the sound sensing unit 110 and then transfers the measured sound pressure to the sound pressure determination unit 143.

The sound pressure measurement unit 141 may employ at least one of an electric resistance variation scheme, which changes electric resistance using sound pressure, a piezo-electric scheme, which changes voltage using sound pressure according to piezo-electric effect, a magnetic force variation scheme, which generates voltage according to vibration of thin metal foil to change magnetic force according to the voltage, a dynamic scheme, in which a movable coil is wound around a cylindrical magnet and the coil is operated by using a vibration plate to utilize electric current generated from the coil, a capacitance scheme, in which a vibration plate including metal foil is disposed in opposition to a fixed electrode to form a condenser and then the vibration plate is vibrated due to sound, thereby changing capacity of the condenser.

The sound pressure determination unit 142 compares the measured sound pressure with a preset reference sound pressure. If the measured sound pressure exceeds the reference sound pressure, the sound pressure determination unit 142 determines that an emergency situation occurs and transmits the determination result to the control unit 150 such that a security service is provided. That is, if the measured sound pressure exceeds a preset sound pressure, the robot tracks a direction of sound, and raises an alarm sound or notifies the user of the emergency situation through the mobile terminal.

The reference sound pressure may be adjusted according to time (daytime and nighttime) or location.

If the user is sleeping at night, the ability of the user to measure the acoustic sound is remarkably degraded as compared with that of the robot. Accordingly, the user sets the reference sound pressure to a low level after a predetermined time has passed at night such that the security service may be provided at a lower sound pressure.

The reference sound pressure is stored in the sound pressure database 142. In addition, the sound pressure database 142 further stores information on the sound pressure of sound, which is generated around the user.

The control unit 150 controls movement of the robot based on a result, which is transmitted from the determination module units 120, 130 and 140, or provides the security service. The control of the control unit 150 will be described in more detail below.

If the transmission result transmitted from the voice sound module 120 or the acoustic sound module 130 represents the sound for communication, the control unit 150 determines the direction of the sound sensed by the sound sensing unit 110, and controls the motor driver 170 such that the robot moves in the direction of the sound. If the sound is generated from plural directions, the control unit 150 again determines the direction of the sound.

In addition, if the transmission result transferred from the sound pressure module 150 represents an emergency situation, the control unit 150 determines a direction of the sound and controls the motor driver 170 such that the robot moves in the direction of the sound or controls the alarm sound output unit 180 to raise alarm sound. Otherwise, the controller 150 transmits a message corresponding to the emergency situation to a user terminal 190 or raises the alarm sound through the user terminal 190.

When sound for communication is detected by at least two modules included in the determination module units, the control unit 150 operates a weight score by applying a weight of a priority corresponding to at least two sounds to the recognition scores. The control unit 150 determines the recognition score having the highest weight and determines a direction of sound corresponding to the highest weight sound such that the robot moves toward the direction of sound.

The control unit 150 sets the priority such that a measurement of sound pressure, which notifies an emergency situation, has the highest priority and the determination of the most frequent sound has the next priority. The priority of a plurality of sounds may be set based on the usage frequency of the sounds by the user or a rank of members in a group.

The module recognizing the sound for communication may further include a whistle module, a bell module or a melody module. Accordingly, when the control unit 150 checks the priority, the score having the highest weight is selected, thereby performing a preset operation corresponding to the selected sound.

As described above, when the sound is sensed, the voice sound or the acoustic sound is detected based on the sensed sound. The detected sound is compared with a preset reference condition (a preset address-term and a pattern of preset acoustic sound), thereby determining if the sound is for communication. If the sound is for communication, the robot is moved in a direction of sound, thereby easily and quickly determining the intention of communication. Accordingly, movement time for the robot may be reduced. In addition, the sound pressure of sensed sound is measured to determine the emergency situation and to provide the security service suitable for the emergency situation, thereby maintaining safety.

The user interface 160 is connected to the control unit 150 of the robot such that different acoustic sound having characteristic of the calling sound, which includes the address-term used to call the robot and the clap sound having different patterns, is additionally added, or the calling sound, which includes the preset address-term and the clap sound, is deleted. Accordingly, the address-term for the robot may be changed according to the command of the user, and the address-term, which is used to call the robot for user's convenience such as ‘hey’ and ‘you’, may be additionally modeled in addition to the name.

When at least two sounds for communication are input, the user interface 160 sets a priority for the sounds.

The motor driver 170 transfers a drive signal to the motor (not shown) according to an order of the control unit 150 such that the robot moves in the direction of the sound for communication.

The alarm sound output unit 180 outputs an alarm sound in a case of emergency, and a user terminal 190 outputs a message or alarm sound in a case of the emergency.

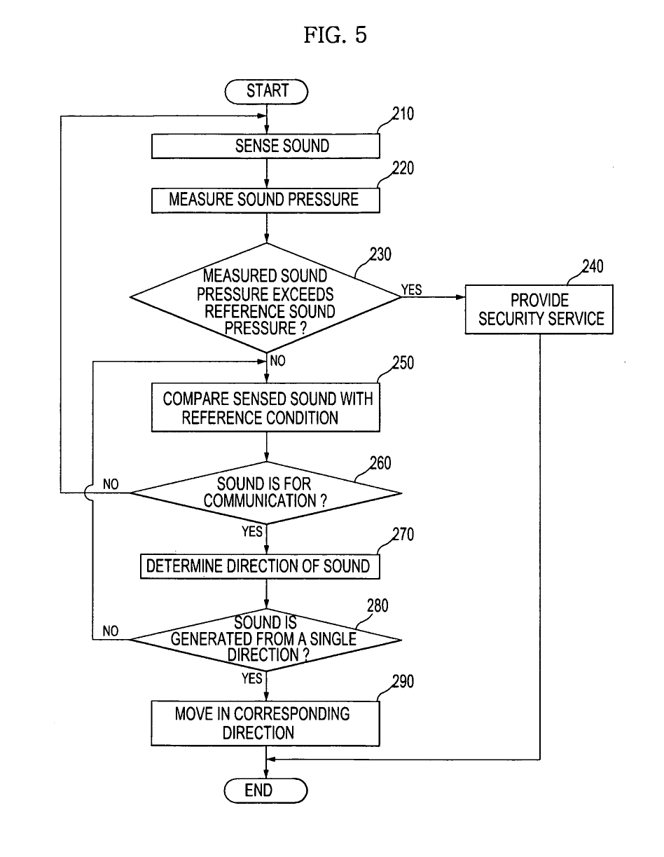

FIG. 5 is a flowchart showing a method for controlling sound recognition according to the embodiment. Hereinafter, the method for controlling sound recognition will be explained with reference to FIGS. 5 to 7.

First, the robot senses sound generated around the robot (210), and measures sound pressure of the sensed sound (220), thereby determining if an emergency occurs.

The measured sound pressure and the reference sound pressure are compared with each other (230). If the measured sound pressure exceeds the reference sound pressure, it is determined that an emergency occurs, so a security service is provided (240). The security service outputs the alarm sound through the alarm sound output unit 180 provided in the robot and transmits a text message corresponding to the emergency situation to the user terminal 190. Otherwise, after trying to make contact with the user terminal 190, if the user terminal 190 is connected to the security service, the voice message corresponding to the emergency situation may be output through the user terminal 190.

If the measured sound pressure is lower than the reference sound pressure, the sensed sound and a preset reference are compared with each other (250), thereby determining if the sensed sound is for communication based on the comparison result (260). The preset reference condition serves to determine if the sensed sound is for communication. The sound for communication includes the calling voice sound to call the robot or the calling acoustic sound, such as the clap sound, to order the robot to come.

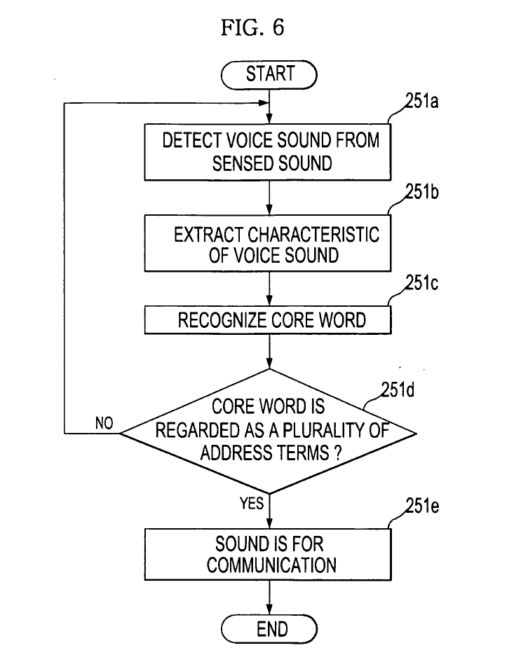

Hereinafter, the comparison (250) of the sensed sound and the preset reference condition will be explained with reference to FIG. 6.

The voice sound signal is detected from the sound sensed through the sound detection unit 110 (251a), and the frequency characteristic of the detected voice sound signal is calculated at each frame, thereby extracting the characteristic vector included in the voice sound signal (251b). The non-keyword is separately and simultaneously molded based on the characteristic vector, thereby calculating the likelihood of the characteristic vector and recognizing the keyword based on the characteristic vector (251c). The recognized keyword is compared with the preset address-term, thereby calculating the likelihood of the keyword representing the state of approaching the address-term. After that, it is determined whether the recognized keyword is one of the preset address-terms according to the result of the likelihood (251d). Based on the determination result, if the recognized keyword is one of a plurality of the address-terms, the sensed sound is considered to have an intention of communication with the user (251e).

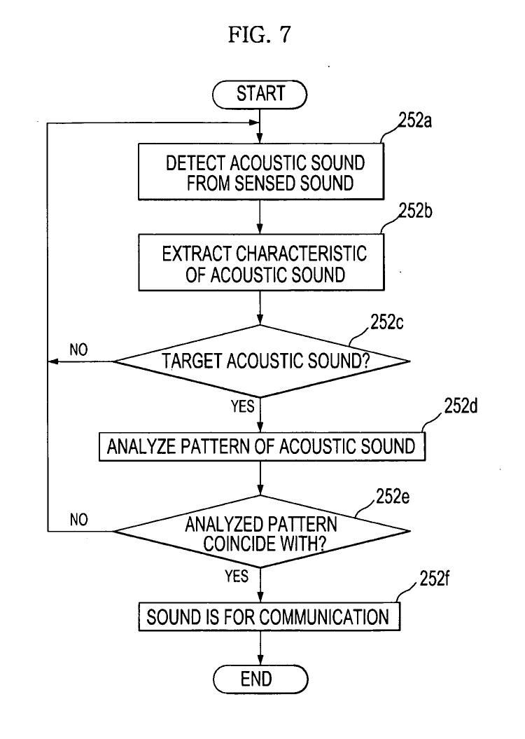

In addition, the comparison (250) between the sensed sound and the preset reference condition will be explained with reference to FIG. 7.

The acoustic sound signal is detected (252a) from the sound sensed through the sound recognition unit 110, and the frequency characteristic of the detected acoustic sound signal is calculated at each frame, thereby extracting the characteristic vector included in the acoustic sound signal (252b). Then, distances between the patterns of the extracted characteristic vector and the patterns of the templates are compared with each other to calculate the distance between the two patterns, thereby determining if the detected acoustic sound is the target acoustic sound. At this time, the minimum distance between the two patterns is extracted, and it is determined whether the minimum distance exceeds the reference distance, thereby determining if the detected acoustic sound corresponds to the target sound (252c). If the minimum distance exceeds the reference distance, the template corresponding to the minimum distance is regarded as the target acoustic sound.

The interval of the patterns of the detected acoustic sound, which has been sensed in the sound sensing unit 110, is compared with the interval of the patterns of the target acoustic sound and the intervals are analyzed (252d), thereby determining if the two patterns have the same interval (252e). If the two patterns have the same interval, the sound is considered to have an intention of communication (252f).

As described above, it is determined if the calling sound is for communication (260). If the calling sound is regarded to have an intention of communication, the direction of the sound is determined (270), and it is determined whether the sound is generated from a single direction (280). If the sound is generated from the single direction, the robot is moved in the direction of the sound (290). If the sound is not generated from a signal direction, the sensed sound is again compared with the preset condition, thereby determining the direction of the sound.

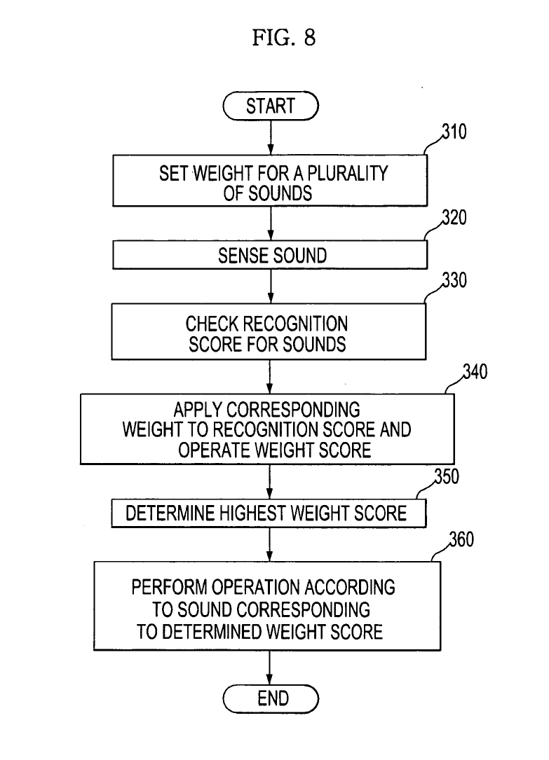

FIG. 8 is a flowchart showing a method for controlling a sound recognition according to another embodiment.

A priority of a plurality of sounds used for calling a robot when a user intends to communicate with the robot, and a weight are set up (310). The priority may be selected by the user or a preset priority may be used. In a state in which the priority of plural sounds for communication has been set, the robot senses various sounds generated around the robot (320).

The sensed sound is compared with a preset reference condition. Then, it is determined whether the sensed sound is for communication based on the comparison result. The preset reference condition serves to determine if the sensed sound is for communication. The sound for communication includes the calling voice sound to call the robot or the calling acoustic sound, such as the clap sound, to ordering the robot to come.

The comparison between the sensed sound and the preset reference condition will be explained below.

The voice sound signal is detected from the sound sensed through the sound detection unit 110, and the frequency characteristic of the detected voice sound signal is calculated at each frame, thereby extracting the characteristic vector included in the voice sound signal. The non-keyword is separately or simultaneously modeled based on the characteristic vector, thereby calculating the likelihood of the extracted characteristic vector. In addition, the keyword is recognized based on the characteristic vector. The extracted characteristic vector is compared with a stored keyword, thereby calculating a likelihood representing a state of approaching to the address-term. If the keyword of the sound is recognized as at least one of the preset address-terms based on the likelihood result, the sound is regarded to have an intention of communication, so that a recognition score is checked (330).

In addition, acoustic sound is detected from the sound sensed through the sound sensing unit 110, and a frequency characteristic of the detected acoustic sound is calculated at each frame, thereby a extracting characteristic vector included in the acoustic sound. A pattern matching is performed with respect to the extracted characteristic vector and the preset templates to compare distances between the two patterns, thereby determining if the detected acoustic sound of the sound sensed by the sound sensing unit 110 corresponds to a target acoustic sound. A minimum distance between the two patterns is extracted and the minimum distance is compared with a reference distance, thereby determining if the minimum distance exceeds the reference distance. If the minimum distance exceeds the reference distance, the template corresponding to the minimum distance is regarded as the target acoustic sound and a recognition score corresponding to the detected acoustic sound is checked (330). If the detected acoustic sound is regarded as the target acoustic sound, an interval of the patterns of the detected acoustic sound is compared with an interval of the patterns of the target acoustic sound. If the pattern of the detected acoustic sound has the interval the same as that of the target acoustic sound, the detected acoustic sound is considered to have an intention of communication.

As described above, if the sound for communication is detected from at least two modules, weight for the priority is applied to the recognition scores corresponding to two sounds, and a weight score is operated (340). A score having the highest weight is determined (350), and the robot is controlled such that the robot moves in the direction of sound corresponding to the weight score (360). The response to the sound for communication may have priority higher than priority of the acceptance of the acoustic sound measurement result, which is intended to provide a security service.

As described above, it is determined if the sound is for communication based on the sound sensed by the robot, thereby increasing recognition rate when a conversation is intended.

Although few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A sound recognition apparatus of a robot, the sound recognition apparatus comprising:
a sound sensing unit to a sense sound; and
a determination module unit, which determines if the sensed sound is for communication by comparing the sensed sound with a preset reference condition.

2. The sound recognition apparatus of claim 1, further comprising a sound pressure measurement unit, which measures a sound pressure of the sensed sound, wherein the determination module unit determines an emergency situation by comparing the measured sound pressure with a reference sound pressure.

3. The sound recognition apparatus of claim 2, further comprising an alarm sound output unit, which outputs an alarm sound if the determination module unit determines that the emergency situation occurs.

4. The sound recognition apparatus of claim 1, further comprising a control unit, which controls the robot such that the robot moves in a direction of the sensed sound if the determination module unit determines the sound is for communication.

5. A sound recognition apparatus of a robot, the sound recognition apparatus comprising:
a sound sensing unit to sense a sound;
a determination module unit, which determines if the sensed sound is for communication by comparing the sensed sound with a preset reference condition; and
a control unit, which controls the robot such that the robot moves in a direction of a sound having a highest priority when a plurality of sounds for communication exist.

6. The sound recognition apparatus of claim 5, further comprising a sound pressure measurement unit, which measures sound pressure of the sensed sound, wherein the determination module unit determines an emergency situation by comparing the measured sound pressure with a reference sound pressure.

7. The sound recognition apparatus of claim 5, further comprising a set-up unit, which sets up a priority corresponding to the sounds, respectively.

8. The sound recognition apparatus of claim 5, wherein the determination module unit comprises:
a voice sound module, which detects a voice sound from the sensed sound to determine if the voice sound is for communication; and
an acoustic sound module, which detects an acoustic sound from the sensed sound to determine if the acoustic sound is for communication.

9. A method of controlling sound recognition of a robot, the method comprising:
sensing a sound;
determining if the sensed sound is for communication comprising comparing the sensed sound with a preset reference condition; and
controlling movement of the robot if determined that the sensed sound is for communication.

10. The method of claim 9, wherein the determination if the sound is for communication comprises:
detecting a voice sound from the sensed sound;
recognizing a keyword from the detected voice sound; and
determining if the keyword corresponds to one of a plurality of address-terms, which are preset.

11. The method of claim 9, wherein the determining if the sound is for communication comprises:
detecting acoustic sound from the sensed sound; and
comparing the detected acoustic sound with a plurality of templates, which are preset.

12. The method of claim 9, further comprising:
measuring a sound pressure of the sensed sound; and
determining an emergency situation, comprising comparing the measured sound pressure with a reference sound pressure.

13. The method of claim 12, further comprising providing a security service if the emergency situation is determined.

14. A method of controlling sound recognition of a robot, the method comprising:
sensing a sound;
determining if the sensed sound is for communication comprising comparing the sensed sound with a preset reference condition;
determining a priority of a plurality of sounds if determined that the sound is for communication; and
controlling the robot such that the robot moves in a direction of the sensed sound having a highest priority.

15. The method of claim 14, further comprising:
measuring sound pressure from the sensed sound; and
determining an emergency situation comprising comparing the measured sound pressure with a reference sound pressure.

16. The method of claim 15, wherein the determination if the sound is for communication has priority higher than priority of the determination of the emergency situation.

17. The method of claim 14, wherein the determination of the priority for the sound comprises:
determining recognition scores of the sounds; and
applying weight to the recognition score corresponding to the priority, thereby operating a weight score.

18. The method of claim 14, wherein the sensing of the sound comprises:
detecting a voice sound from the sound;
recognizing a keyword from the detected sound;
comparing the keyword with a plurality of address-terms, which are preset, thereby determining a consistency between the keyword and the address-terms; and
determining a recognition score of the address-terms having consistency with the keyword.

19. The method of claim 14, wherein the sensing of the sound comprises:
detecting an acoustic sound from the sensed sound; and
comparing a distance between a pattern of the detected acoustic sound and a pattern of a plurality of templates, which are preset, thereby recognizing a target acoustic sound.

20. The method of claim 19, wherein the recognizing of the target acoustic sound comprises recognizing the template corresponding to a minimum distance as the target acoustic sound.

21. The sound recognition control method of claim 19, wherein an interval between the pattern of the detected acoustic sound and a pattern of the target acoustic sound, thereby determining if the sound is for communication.
